(19) United States
(12) Patent Application Publication
(10) Pub. No.: US 2019/0163152 A1
(43) Pub. Date: May 30, 2019

(54) POWER SHARING IN A MESH ENERGY SYSTEM

(71) Applicant: Iteros, Inc., San Diego, CA (US)

(72) Inventors: Jennifer Michelle Worrall, San Diego, CA (US); Arturo N. Villanueva, San Diego, CA (US)

(21) Appl. No.: 16/322,018

(22) PCT Filed: Aug. 10, 2017
(86) PCT No.: PCT/US2017/046334

§ 371 Date: Jan. 30, 2019

Related U.S. Application Data
(60) Provisional application No. 62/373,810, filed on Aug. 11, 2016.
(60) Provisional application No. 62/373,869, filed on Aug. 11, 2016.
(60) Provisional application No. 62/373,886, filed on Aug. 11, 2016.

(51) Int. Cl. G05B 19/042; H02J 3/38; H02J 13/00

(52) U.S. Cl. CPC G05B 19/042; H02J 3/381; H02J 2003/003; G05B 2219/2639; H02J 13/0013

(57) ABSTRACT

Systems, devices and methods for sharing energy are generally described. In various examples a first grid participant may send a request for a list of grid participants to a directory server. The first grid participant may determine an energy profile of the first grid participant. The first grid participant may send a first signal to a second grid participant of the list of grid participants. The first signal may comprise a first indication of the energy profile of the first grid participant. The first grid participant may receive a response from the second grid participant indicating an availability of the second grid participant to participate in energy sharing with the first grid participant. Energy may be provided to a line accessible by the first grid participant and the second grid participant according to the energy profile of the first grid participant.

### CROSS-REFERENCE TO RELATED APPLICATIONS

This application claims the benefit of U.S. Provisional Application No. 62/373,886 filed on Aug. 11, 2016, U.S. Provisional Application No. 62/373,810 filed on Aug. 11, 2016, and U.S. Provisional Application No. 62/373,869 filed on Aug. 11, 2016, the disclosures of which are hereby incorporated herein by reference in their entirety.

### FIELD

This application relates to electric power distribution.

### BACKGROUND

In the developed world, there has been a massive change in the character of the power distribution grid over the previous decade, primarily due to the proliferation of renewable energy installations at the site of energy consumption. In rural areas across the globe, renewable energy provides a new pathway to enable growth of their local economies. More of the energy consumed is controllable via the Internet of Things, such as thermostats, lighting, electric vehicles, and plug loads.

### SUMMARY

Systems and methods are provided for power sharing in a mesh energy system in accordance with the various embodiments described herein.

In accordance with embodiments of the present invention, methods of energy sharing are generally described. In various examples, the methods may include sending, by a first computing device associated with a first grid participant, a request for a list of grid participants to a directory server. In some further examples, the methods may include receiving, by the first computing device, the list of grid participants from the directory server. In various other examples, the methods may include determining, by the first computing device, an energy profile of the first grid participant. In some examples, the methods may include sending, by the first computing device, a first signal to a second grid participant of the list of grid participants. In some other examples, the first signal may include a first indication of the energy profile of the first grid participant. In yet other examples, the methods may further include receiving, by the first computing device from a second computing device associated with the second grid participant, a second signal in response to the first signal. In some examples, the second signal may indicate an availability of the second grid participant to participate in energy sharing with the first grid participant. In various further examples, the methods may include providing energy to a line accessible by the first grid participant and the second grid participant according to the energy profile of the first grid participant.

In some other examples, computing devices effective to share power are generally described. In at least some examples, the computing devices may be associated with a first grid participant. In some examples, the computing devices may include at least one processor and a memory configured in communication with the at least one processor. In various examples, the memory may store instructions that when executed by the at least one processor cause the computing devices to perform a method. In some examples, the method may include sending a request for a list of grid participants to a directory server. In some further examples, the method may include receiving the list of grid participants from the directory server. In various other examples, the method may include determining an energy profile of the first grid participant via communication with a smart meter of the first grid participant. In various examples, the communication may be in a first communication protocol. In various further examples, the method may include sending a first signal in a second communication protocol to a second grid participant of the list of grid participants. In some examples, the first signal may include a first indication of the energy profile of the first grid participant. In further examples, the methods may include receiving, from a second computing device associated with the second grid participant, a second signal in response to the first signal. In at least some examples, the second signal may indicate an availability of the second grid participant to participate in energy sharing with the first grid participant. In some further examples, the method may include providing energy to a line accessible by the first grid participant and the second grid participant according to the energy profile of the first grid participant.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF DRAWINGS

FIG. 1 depicts an example representation of a power network including a number of grid participants electrically coupled to one another, in accordance with various aspects of the present disclosure.

FIG. 2 depicts a representation of a grid participant, in accordance with various aspects of the present disclosure.

FIG. 3 depicts an example of a solar photovoltaic grid participant sharing power with a local utility grid participant, in accordance with various aspects of the present disclosure.

FIG. 4 depicts an example of a building management system grid participant communicating with an aggregator grid participant, in accordance with various aspects of the present disclosure.

FIG. 5A depicts an example of a consumer device grid participant communicating with a utility grid participant, in accordance with various aspects of the present disclosure.

FIG. 5B depicts an alternate example of the consumer device grid participant of FIG. 5A communicating with a different grid participant, in accordance with various aspects of the present disclosure.

FIG. 6 depicts an example comprising two microgrid grid participants, in accordance with various aspects of the present disclosure.

FIG. 7 depicts an example communication process between two grid participants, in accordance with various aspects of the present disclosure.

FIG. 8 depicts example communication and signal processing of two participants, in accordance with an embodiment of the present disclosure.

FIG. 9 depicts an example process for communicating with a directory server, in accordance with various aspects of the present disclosure.

FIG. 10 depicts an example process for broadcasting signals to other grid participants, in accordance with various aspects of the present disclosure.

FIG. 11 illustrates components of a computing device, in accordance with various embodiments of the present disclosure.

### DETAILED DESCRIPTION

In the following description, reference is made to the accompanying drawings that illustrate several embodiments of the present disclosure. It is to be understood that other embodiments may be utilized and system or process changes may be made without departing from the spirit and scope of the present disclosure. The following detailed description is not to be taken in a limiting sense, and the scope of the embodiments of the present invention is defined only by the claims of the issued patent. It is to be understood that drawings are not necessarily drawn to scale.

Various embodiments of the present disclosure provide improved systems and methods for sharing power in a decentralized mesh energy network. These embodiments may provide for dynamic distribution of energy using near real-time energy data to share energy among participating grid participants. Advantageously, the methodologies and systems described herein can be used with existing infrastructure and with the variety of different and incompatible communication protocols and standards already in use without requiring additional and expensive infrastructure. The methods and systems described herein provide for bilateral communication between remotely located grid participants and allow for load-balancing across a power grid, increasing the efficiency of energy production and energy sharing.

The proliferation of renewable energy resources and microgrids have created challenges for local energy utilities who now must contend with fluctuations in generated power and back-feeding from over generation. Local power generation eliminates the requirement for the massive infrastructure needed to connect to a regional energy grid. However, the problems associated with intermittency of power generated by the renewable energy resources and the need to carefully balance loads with a limited power supply remain. There have been a number of previous methods introduced that allow optimization of energy usage for a single participant in the grid, for demand reduction in an area, or for the aggregation of these assets into a single controllable, “dispatchable,” resource. However, each of the previous solutions requires specific software and/or equipment to be installed at the site of each participant, and no consideration is made for passive participants who have neither localized energy generation nor dispatchable loads.

Various techniques described herein allow for bilateral communication between various grid participants via agent computing devices. Existing optimization methods have no provisions for the bilateral sharing of energy between participants, which unlike localized optimization, or the broad strokes of demand response at the power utility level, can create a more efficient usage of power system-wide. Some consumer devices can be connected to the utility-installed Smart Meter/Advanced Metering infrastructure (AMI) to provide the utility some capacity for load reduction as needed. As described below, “agents” representing energy grid participants (e.g., energy consumers and/or producers) may be deployed in pre-existing systems through software or may be instantiated as hardware devices. Additionally agents may allow for fully decentralized sharing of power between various grid participants. The effectiveness of optimization increases with the number of participants due to the decentralization of power sharing, making the solutions described herein more scalable and holistic relative to previous techniques. Further, as described herein, agent devices may establish bilateral communication using existing standards and protocols to allow for localized load-balancing using pre-existing infrastructure.

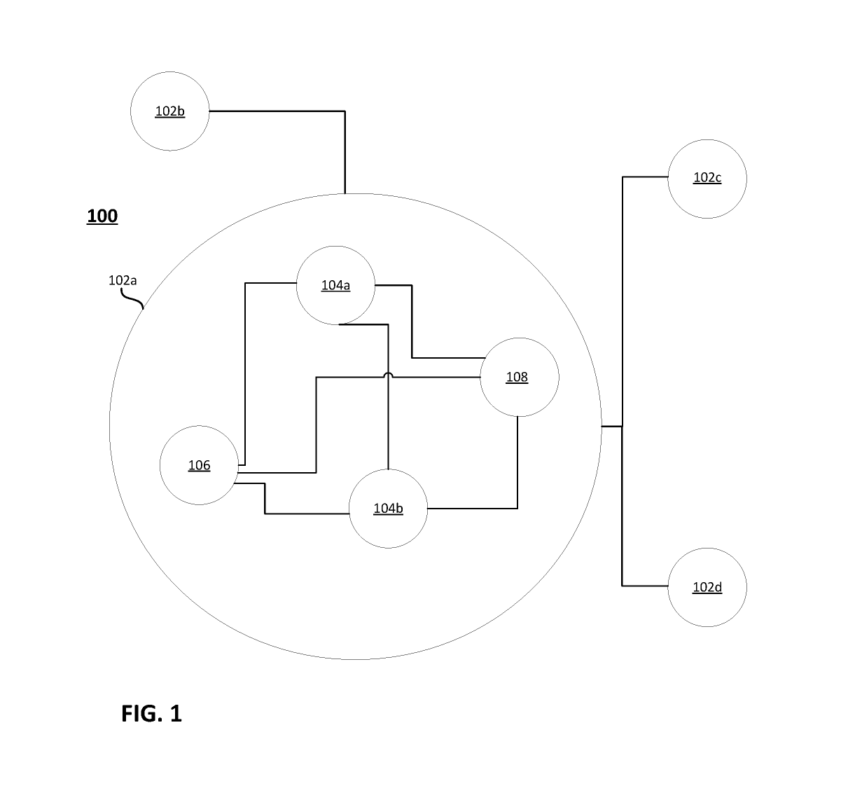

Power networks as described herein comprise an electrical grid with various grid participants participating in the consumption, production and/or storage of electrical power. FIG. 1 depicts an example representation of a power network 100 including a number of grid participants electrically coupled to one another. The various elements and combinations of elements shown in FIG. 1 are depicted for illustrative purposes only. Other arrangements, combinations, types, and/or numbers of elements, beyond what is shown in FIG. 1, are explicitly contemplated in accordance with the present disclosure. The example power network 100 comprises grid participants 102a, 102b, 102c and 102d. Grid participants 102 (including grid participants 102a, 102b, 102c and/or 102d) may further comprise one or more energy components. For example, grid participant 102a comprises energy generators 104a and 104b, energy storage 106, and energy load 108. In the example depicted, each of the energy components (e.g., energy generators 104a and 104b, energy storage 106, and energy load 108) are coupled to one another and are in communication with one another. Other grid participants (e.g., grid participants 102b, 102c and/or 102d depicted in FIG. 1) may not necessarily include the same types and/or quantities of the energy components depicted in grid participant 102a. Energy generators (e.g., energy generators 104a and 104b of grid participant 102a) may be any source of energy. In some examples, energy generators may include renewable sources of energy such as solar photovoltaic panels, wind turbines, etc. and/or non-renewable sources of energy such as diesel generators, etc. Energy may be generated by and flow away from energy generators.

Energy loads (e.g., energy load 108) may be any energy-consuming device, system or element. For example, energy loads may include refrigerators, load banks, heating, ventilation and air conditioning (HVAC) systems, motors, lighting systems, etc. In various cases, a single energy load represented as an element of a microgrid may represent the cumulative electrical load of energy-consuming devices, systems and/or elements of the particular microgrid and/or of a facility, building, and/or other power-consuming unit of the particular microgrid. Energy may flow toward and be consumed by energy loads.

Energy storage (e.g., energy storage 106) may be any system capable of storing energy, acting as an energy buffer, and/or providing temporary containment of energy. Various examples of energy storage include batteries (e.g., lithium-ion batteries), capacitors, flow batteries, and/or flywheels. Energy may flow toward energy storage in order to charge the storage. Additionally, energy may flow away from energy storage when the energy storage is discharged.

In at least some examples, grid participants 102 (e.g., grid participants 102a, 102b, 102c, and/or 102d) may be microgrids. Microgrids may be considered as a specialized form of energy storage. Microgrids typically comprise a combination of one or more of energy generators, energy loads, and/or energy storage devices. It is to be appreciated that a microgrid may not include all of the various energy components described herein. For example, microgrids 102b, 102c, and/or 102d may not necessarily include the same number and/or same type of components as depicted in microgrid 102a. Additionally, in some examples, microgrids may include additional components not described in reference to FIG. 1. In FIG. 1, microgrids 102a, 102b, 102c, and/or 102d may each be considered a grid participant. In addition, one or more additional grid participants (not shown in FIG. 1) may be part of power network 100.

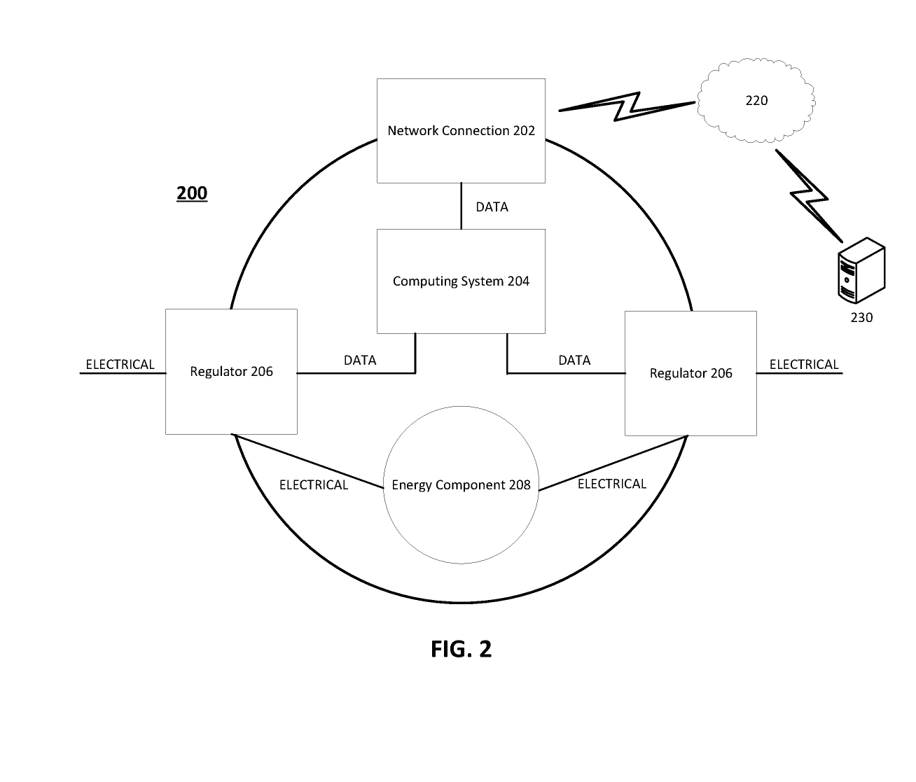

FIG. 2 depicts a general representation of an example grid participant 200. In the example depicted in FIG. 2, a grid participant may include one or more energy components 208, computing system 204, and/or a network connection 202. Additionally, a grid participant may comprise transmitter/receiver elements effective to send and receive, respectively, data over one or more networks, such as network 220. In some examples, a gird participant may include one or more regulators 206. In various examples, grid participant 200 may send data over network 220 to one or more other grid participants and/or to a server device, such as server 230, described in further detail below. It should be appreciated that while the example grid participant 200 of FIG. 2 is shown and described with various numbers and types of components, generally grid participants may include other numbers and types of components in accordance with the present disclosure. For example, in at least some embodiments, regulators 206 may be omitted from grid participant 200.

Regulator 206 may be, for example, a piece of equipment that manages the flow of electricity through one or more conducting wires coupled to regulator 206. Regulator 206 may be effective to control both inflow and outflow by adjusting current, voltage or both.

Computing system 204 may be any type of computing device and, in various examples may include one or more microprocessors, a storage element, and/or input/output components. Computing system 204 may interface with various other components of grid participant 200 and may be effective control the various other components and/or gather data related to the various other components of grid participant 200.

Network connection 202 may allow grid participant 200 to send and receive data to one or more other computing devices and/or grid participants over a network, such as network 220. Additionally, one or more other computing devices and/or grid participants may be able to remotely provide instructions to computing system 204 through network connection 202 in order to control various operations of computing system 204 and/or in order to remotely control operation of one or more other components of grid participant 200 by interfacing with computing system 204.

Energy component 208 may comprise one or more of an energy generator (e.g., energy generators 104a, 104b described above in reference to FIG. 1), an energy storage (e.g., energy storage 106 described above in reference to FIG. 1), an energy load (e.g., energy load 108 described above in reference to FIG. 1), and/or a microgrid (e.g., microgrids 102a, 102b, 102c, and/or 102d described above in reference to FIG. 1). As depicted in FIG. 2, energy component 208 may be coupled to one or more regulators 206 via electrical couplings (e.g., conductors that allow electrical connection of various components). In at least some further examples, energy component 208 may be effective to transmit data to computing system 204.

In various examples described herein, computing system 204 may be referred to as an “agent”. Generally, agents may be effective to monitor and/or forecast energy consumption by a grid participant associated with the agent (e.g., grid participant 200). As described in further detail below, agents may receive signals from other agents of one or more remotely located grid participants. Additionally, agents may send signals to one or more remotely located agents. As described below, through bilateral communication with a network of agents (and thus a network of grid participants), a mesh network of bilaterally communicating grid participants may share energy in a distribution-level grid and may achieve load balancing using existing standards and protocols as well as existing infrastructure. Bilateral signaling and energy sharing may optimize energy distribution based on such factors as availability of power, sustainability of available power resources, criticality of energy loads, energy forecasts/profiles of individual grid participants, etc. In various examples, agents may comprise and/or be configured in communication with a computing system, such as computing system 204 depicted in FIG. 2. Agents may further comprise at least one signal processor, a memory effective to store a database of historical grid participant usage and/or output, and a forecast generator, effective to forecast future energy needs based on historical power consumption data, machine learning, and/or reference to external resources (e.g., weather service data repositories, production schedules, etc.).

Currently, Smart Meters/AMI may provide near real-time information to utilities and/or customers, but may not be able to manipulate the energy consumption of a grid participant associated with the Smart Meter/AMI. Smart solar inverters allow utilities to send signals effective to curtail energy generated, but do not provide an option for grid participants to shift loads to consume more power when power production/supply is plentiful (e.g., when a surplus of power is generated beyond current load requirements). Home automation enthusiasts are becoming more plentiful and may have opportunities for manipulating their load profile, but may not have a uniform way to receive signals from other grid participants. Microgrids provide resiliency for localized service, but do not extend the resiliency to surrounding areas. Additionally, a variety of different protocols and standards are currently used for communication of power-related data. For example, utilities use IEEE 2030.5/Smart Energy Profile 2.0 for smart thermostat programs and communications to smart inverters, but many home automation enthusiasts prefer If-This-Then-That (IFTTT) or use of a smart hub to send and receive power-related signals. Utilities may use Open ADR profiles to send demand response requests to large commercial and industrial companies, but the infrequency of transmission of such signals disincentivizes the investment in infrastructure that is able to accept such signals. In addition, other signaling standards are used to communicate power-related data between various devices. For example, the OASIS standard (e.g., EMIX and TEMIX), SCADA protocols (e.g., MODBUS, DNP3), and Internet of Things (IoT) platforms (e.g., Z-Wave, ZigBee, etc.) are a few examples of the many protocols currently used to send and receive power-related data. Accordingly, as described herein, agents may be effective to translate data from one standard and/or protocol into another and rebroadcast the translated signal in order to effectively disseminate power data within the mesh-network topology described herein. In various subsequent figures, examples are depicted and described related to example operations of power sharing in a mesh energy system in accordance with various aspects of the present disclosure.

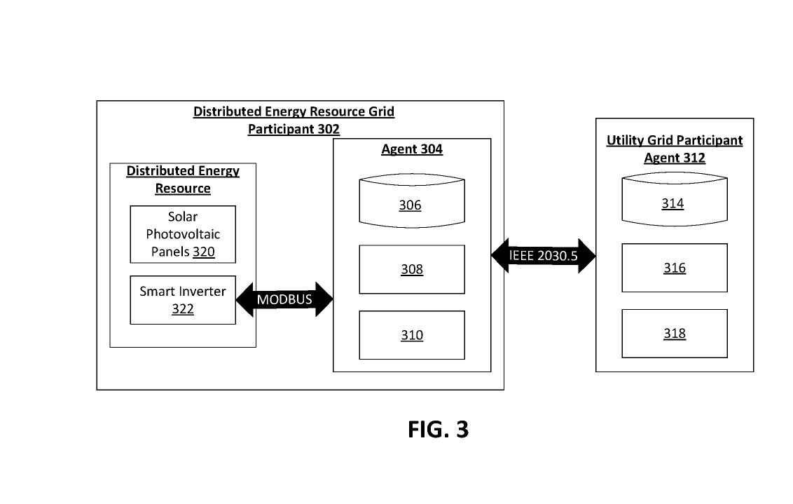

FIG. 3 depicts an example of a solar photovoltaic system (e.g., grid participant 302) engaging in bilateral communication and sharing power with a local utility grid participant, in accordance with various aspects of the present disclosure. Grid participant 302 may comprise an agent 304. As previously described, agent 304 may be instantiated in dedicated hardware, may be a software module executing on a Smart Meter/AMI, and/or may be hosted externally where a data feed of required data is available (e.g., as provided by the U.S. Department of Energy's Green Button program). Agent 304 may comprise a memory 306, one or more signal processors 308, and/or a forecast generator 310. Similarly, agent 312 at the utility grid participant may comprise a memory 314, one or more signal processors 316 and/or a forecast generator 318. Grid participant 302 may further comprise solar photovoltaic panels 320 and a smart inverter 322.

In the example depicted in FIG. 3, the solar energy resource grid participant 302 may communicate and/or share energy with the local utility (e.g., grid participant 312). Agent 304 monitors and stores relevant energy production (e.g., energy production by solar photovoltaic panels 320). Additionally, forecast generator 310 may forecast future energy production based on historical data, sensors, and/or data received from external resources (e.g., from weather plug-in provided by a weather service). Accordingly, agent 304 may generate an energy profile for grid participant 302. The energy profile may describe the amount of energy available for sharing based on current energy storage, current energy production, current loads, and based on forecasted energy production, loads, storage and preexisting energy commitments. In various other examples, the energy profile may describe the amount of energy required from external sources in order to satisfy current and/or forecasted energy requirements. When used in the context of forecasted or requested energy, the terms “requirement” and “requirements” represent indications of desired or expected energy amounts, usage, or demand, and do not necessarily indicate a strict requirement that must be met in order for the various systems described herein to operate. As depicted in FIG. 3, smart inverter 322 may communicate with agent 304 via MODBUS. Agent 304 may, in turn, communicate with the agent 312 of the local utility grid participant using the IEEE 2030.5 standard as utilities are typically configured to accept IEEE 2030.5 communications.

In an example, the utility grid participant may only be able to supply a portion of the amount of energy requested by agent 304 based on an energy profile of the utility grid participant. Accordingly, agent 312 may send a message indicating a partial acceptance including the amount of energy that the utility grid participant is able to supply at the requested time. In such an example, prior to sending the portion of energy from the local utility to grid participant 302, agent 312 may await a signal from agent 304 via IEEE 2030.5 requesting that the portion of energy be sent by agent 312.

In another example, agent 304 of grid participant 302 may determine based on the energy profile of grid participant 302 (e.g., based on forecasted energy production and energy load, current storage levels, current load levels, etc.) that a surplus of energy may be produced by the solar photovoltaic panels 320. Accordingly, agent 304 may send a signal to agent 312 indicating the surplus amount of energy available. If agent 312 determines that additional energy is needed by the utility grid participant associated with agent 312 in order to satisfy current energy requirements/obligations, agent 312 may send an IEEE 2030.5 signal to agent 304 accepting the indicated amount of energy. Accordingly, upon receipt of the signal from agent 312 accepting the surplus energy, agent 304 may send the surplus amount of energy to the utility grid participant via existing infrastructure (e.g., transmission and/or distribution lines).

Alternatively, if agent 312 determines that the additional energy offered by agent 304 is not required to meet current demands on the utility grid participant, agent 312 may send a “curtail” signal using the IEEE 2030.5 standard. Agent 304 may receive the curtail signal and may convert the curtail command to a command type that is executable by the smart inverter 322. The curtail command, when executed by the smart inverter 322 may be effective to reduce or prevent power generation by solar photovoltaic panels 320.

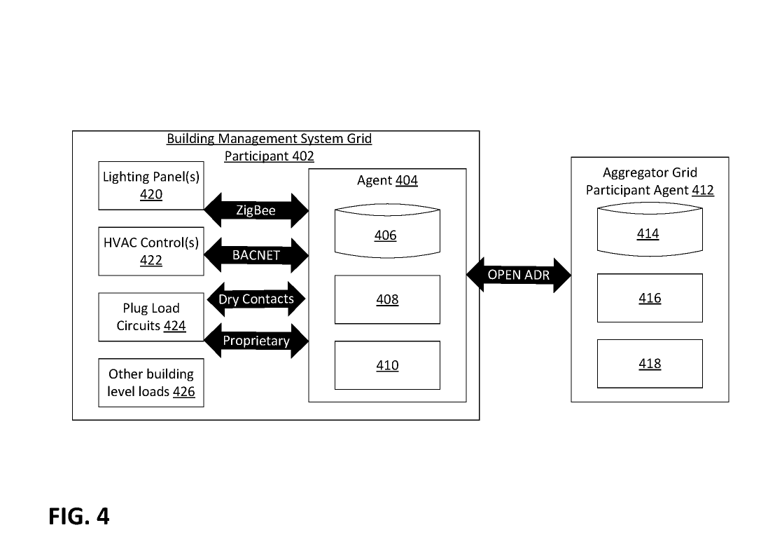

FIG. 4 depicts an example of a building management system grid participant 402 communicating with an agent 412 of an aggregator grid participant, in accordance with various aspects of the present disclosure. Agent 404 of building management system grid participant 402 may comprise a memory 406, one or more signal processors 408, and/or a forecast generator 410. Grid participant 402 may further comprise various loads, such as lighting panels 420, HVAC control(s) 422, plug load circuits 424, and/or other building level loads 426. Similarly, agent 412 at the utility grid participant may comprise a memory 414, one or more signal processors 416 and/or a forecast generator 418.

Agent 404 may be instantiated in and/or be in communication with a smart meter and may monitor and record energy information with enough detail to determine the relative contribution of various loads and may produce a forecast of energy usage in the aggregate. Agent 404 may be effective to communicate with the various loads via various applicable standards. For example, in the illustrative embodiment depicted in FIG. 4, agent 404 may communicate with the various loads using ZigBee, BACNET, and/or proprietary protocols. Additionally, in some examples, agent 404 and/or a Smart Meter/AMI configured in communication with agent 404 may monitor dry contacts of one or more loads of grid participant 402. If desired to meet the energy demands of the building management grid participant 402, agent 404 may send a signal via Open ADR to aggregator grid participant agent 412 requesting the amount of energy desired. In the example, agent 412 may be use various determination factors such as current electricity prices, the availability of energy from renewable resources versus non-renewable resources, a current storage capacity of an energy storage resource associated with the aggregator grid participant, current energy obligations of the aggregator grid participant, etc. to determine that only a portion of the requested power can be supplied at the current time to grid participant 402. Accordingly, agent 412 may send a signal to agent 404 including the specified reductions. Agent 404 may receive the signal and may translate the result to a demand response event with actionable commands for the various loads (e.g., lighting panel(s) 420, HVAC Control(s) 422, Plug Load Circuits 424, and/or other loads 426) configured to be in communication with agent 404 using the pertinent communication protocols, such as ZigBee, MODBUS, and/or electrical signals through dry contacts. Grid participant 402 may receive the portion of the requested energy from the aggregator grid participant. Thereafter, agent 404 may update forecasted and current energy requirements accordingly.

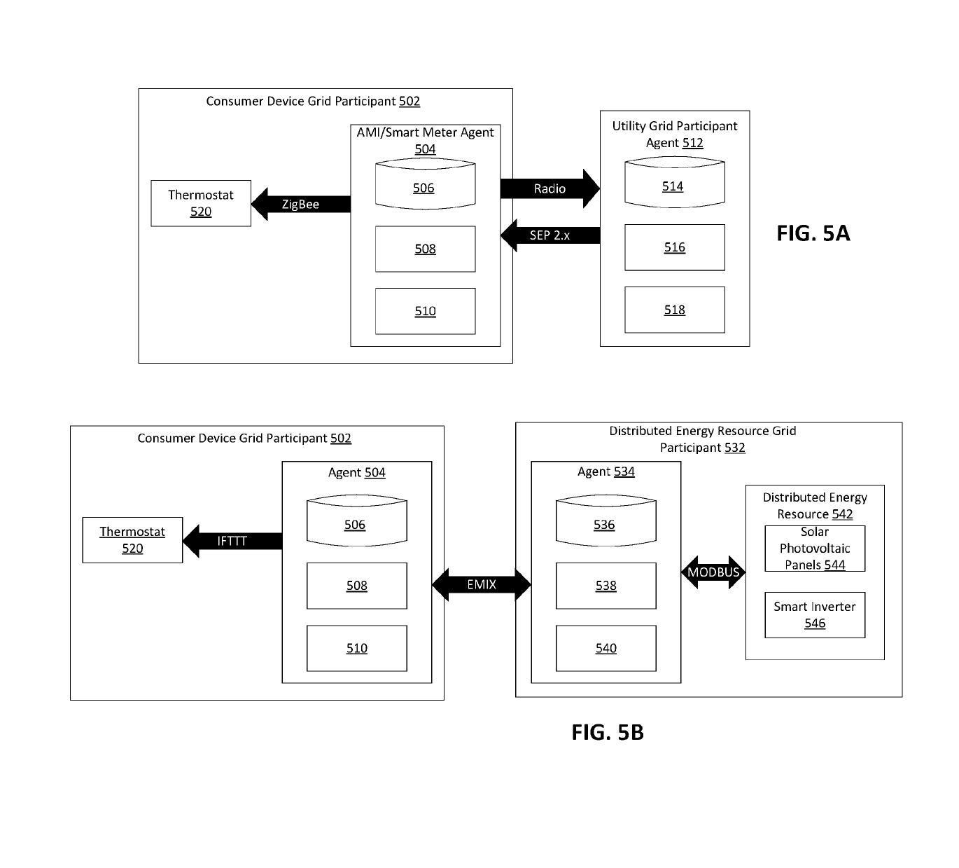

FIG. 5A depicts an example of a consumer device grid participant 502 communicating with an agent 512 of utility grid participant, in accordance with various aspects of the present disclosure. Agent 504 of consumer device grid participant 502 may comprise a memory 506, one or more signal processors 508, and/or a forecast generator 510. Similarly, agent 512 at the utility grid participant may comprise a memory 514, one or more signal processors 516 and/or a forecast generator 518.

Agent 504 of consumer device grid participant 502 may be, in various examples, a software module installed on a smart meter/AMI associated with the consumer device grid participant 502. Grid participant 502 may further comprise a smart thermostat 520 effective to communicate with agent 504 through the ZigBee standard. In addition to smart thermostat 520, agent 504 may represent other loads of grid participant 502 (e.g., other household loads such as the refrigerator, air conditioning, lighting, etc.).

In the example depicted in FIG. 5A, the agent 504 may determine an amount of energy desired by loads of grid participant 502 and may send a signal to other grid participants (including to utility grid participant agent 512) according to the current amount of energy desired by grid participant 502. At the time agent 512 receives the signal from agent 504, the utility grid participant represented by agent 512 may be facing voltage regulation difficulties in the evening hours, due to excessive loads, for example. Accordingly, agent 512 may respond to agent 504 with a signal via the IEEE 2030.5/Smart Energy Protocol 2.0 standard, requesting that agent 504 reduce the load and/or supply energy to the utility grid participant represented by agent 512. The smart meter/AMI comprising agent 504 may accept the IEEE 2030.5/Smart Energy Protocol 2.0 reply from the utility grid participant and may translate the signal to ZigBee protocol for transmission to the thermostat 520. In response, the thermostat 520 may reduce energy requirements and update agent 504. Agent 504 may, in turn, send an updated signal including the reduced current energy requirements to one or more grid participants. The signal from agent 504 may request the current amount of energy needed by grid participant 502 after the reduction in the load of thermostat 520.

FIG. 5B depicts an alternate example of the consumer device grid participant 502 of FIG. 5A communicating with a distributed energy resource grid participant 532, in accordance with various aspects of the present disclosure. Agent 534 at the distributed energy resource grid participant 532 may comprise a memory 536, one or more signal processors 538 and/or a forecast generator 540. Additionally, in the example depicted in FIG. 5B, distributed energy resource grid participant 532 may comprise a distributed energy resource 542 including a plurality of solar photovoltaic panels 544 and a smart inverter 546.

In the example depicted in FIG. 5B, thermostat 520 communicates with agent 504 via the If-This-Then-That (IFTTT) protocol. Agent 504 may determine an amount of energy required by loads of grid participant 502 and may send a signal to other grid participants (including to utility grid participant agent 532) according to the current amount of additional energy required by grid participant 502. Additionally, the agent 504 may forecast the amount of energy needed by grid participant 502 using forecast generator 510 and may generate a signal using the EMIX standard requesting the current and/or forecasted amount of energy from one or more grid participants, including from the distributed energy resource grid participant 532 represented by agent 534.

Agent 534 may respond with an EMIX signal including an indication of a currently available and/or a forecasted amount of energy which grid participant 532 is able to provide to grid agent 504. Agent 504 may accept the signal and may update the amount of energy required by grid participant 502 accordingly. For example, the amount of energy to be supplied by grid participant 532 may be subtracted from the total energy requirement of grid participant 502. Accordingly, a subsequent signal from agent 504 requesting energy from one or more grid participants may request a lesser amount of energy due to the energy supplied by grid participant 532. Additionally, agent 534 of grid participant 532 may update signaling and/or an amount of available energy based on the amount supplied to grid participant 502, as appropriate.

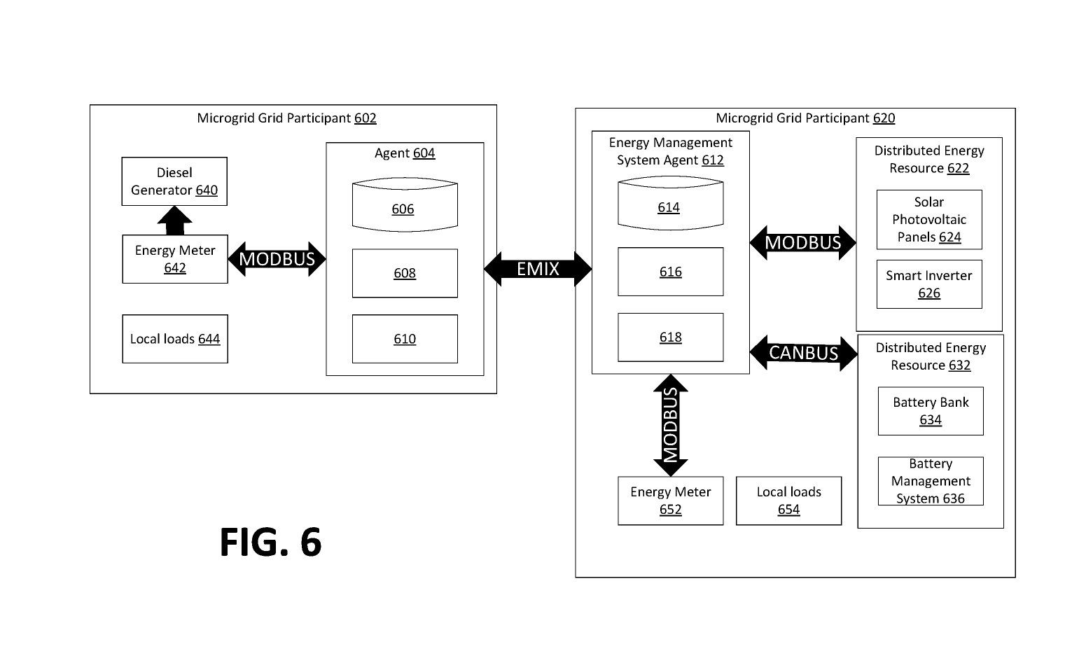

FIG. 6 depicts an example comprising two microgrid grid participants (e.g. microgrid grid participant 602 and microgrid grid participant 620), in accordance with various aspects of the present disclosure. Microgrid grid participant 602 may comprise a diesel generator 640 that follows loads of microgrid grid participant 602 (e.g., diesel generator 640 generates exactly enough power to cover the energy consumers of microgrid grid participant 602) but has no capacity to control the attached loads. Microgrid grid participant 620, on the other hand, may comprise distributed energy resource 622 including solar photovoltaic panels 624 and a smart inverter 626. Additionally, microgrid grid participant 620 may use battery storage to augment solar production by storing unused power and discharging it at night or when there is not enough power generated via the solar photovoltaic panels 624. In the example depicted, if agent 612 of microgrid grid participant 620 determines via forecast generator 618 that extra solar generation will yield a surplus of energy and a level of battery storage in battery bank 634 that exceeds a threshold storage requirement, agent 612 may send a signal via the EMIX protocol to one or more other grid participants stating that additional energy is available, and specifying the anticipated amount.

Agent 604 of microgrid grid participant 602 may comprise a memory 606, one or more signal processors 608, and/or a forecast generator 610. Similarly, agent 612 at the microgrid grid participant 620 may comprise a memory 614, one or more signal processors 616 and/or a forecast generator 618. Distributed energy resource 632 of microgrid grid participant 620 may comprise a battery bank 634 and/or a battery management system 636 effective to store and disseminate power as needed by local loads 654 and/or by agent 612. Microgrid grid participant 602 may comprise local loads 644. In various examples, energy meter 642 may monitor local loads 644 and may monitor energy production by diesel generator 640. Similarly, in various examples energy meter 652 of microgrid grid participant 620 may monitor energy production by distributed energy resource 622 and may monitor local loads 654.

In the example, agent 604 of microgrid grid participant 602 may receive the signal from agent 612. In the example, agent 604 may programmatically prioritize renewable energy sources over non-renewable energy resources and may thus accept the energy offered by grid participant 620 in lieu of operating diesel generator 640 to accommodate the energy needs of microgrid grid participant 602. Each grid participant (602, 620) may thereafter update outbound signals and the energy forecast of each grid participant to reflect the current energy requirements/availability.

Generally, forecasting of energy availability and/or energy requirements by a grid participant may be performed by a forecast generator (e.g., forecast generator 310 depicted in FIG. 3) configured in communication with an agent. Forecasting of energy availability and/or requirements may be based on recorded historical energy usage. In one example, a grid participant may forecast the energy consumption of a particular load (e.g., a smart light) will be the same for the next time period as it was for the previous time period. In various other examples, forecasting may use historical data, sensors, and/or external resources in a machine learning environment in order to estimate future energy requirements and/or availability. For example, a forecast generator of an agent for a solar photovoltaic system may use historical data for the given month of the year, combined with input from one or more irradiance sensors and input from an external weather service to forecast an amount of energy that will be produced over the next time period (e.g., minutes, hours, days, weeks, etc.).

Grid participants communicate with one another to participate in the mesh energy system described in embodiments of the present disclosure. Because a variety of different pre-existing systems are in place, it is unrealistic to expect that all components of all grid participants will communicate using the same standard and/or communication protocol. Accordingly, the foregoing examples have described a variety of different communication protocols and standards. To create a decentralized network, messages are broadcast to all appropriate grid participants. Although the embodiments described above in reference to FIGS. 1-6 depict only a few grid participants, the signals broadcast by the grid participants in these foregoing examples are also sent to additional grid participants. Additionally, signals received by grid participants other than those shown in the foregoing embodiments may also be received and acted on by other grid participants. Because some agents may be unable to communicate via various standards and/or communication protocols, various agents may be effective to translate signals between standards and/or protocols and rebroadcast the signals. In at least some examples, a directory server (e.g., server 230 depicted above in FIG. 2), may store data regarding which grid participants include agents that offer a translation/rebroadcasting service and which communication protocols and/or standards are supported by the various agents. An example of an appropriate translation/rebroadcast would be an OpenADR 2.0 (typically a commercial signal) signal to Simple Energy Protocol 2.0 (typically a residential signal) signal, where both of the signals have the goal of demand reduction. Conversely, rebroadcasting an EMIX signal (typically transactive) to a passive energy consumer (e.g., non-dispatchable energy consumer) does not provide an energy-sharing benefit, except in the sense that in the grid as a whole, a reduction in demand by some consumers will free up the energy for a different energy consumer. Accordingly, rebroadcasting of EMiX signals to passive energy consumers may be avoided in some example implementations in order to reduce network traffic.

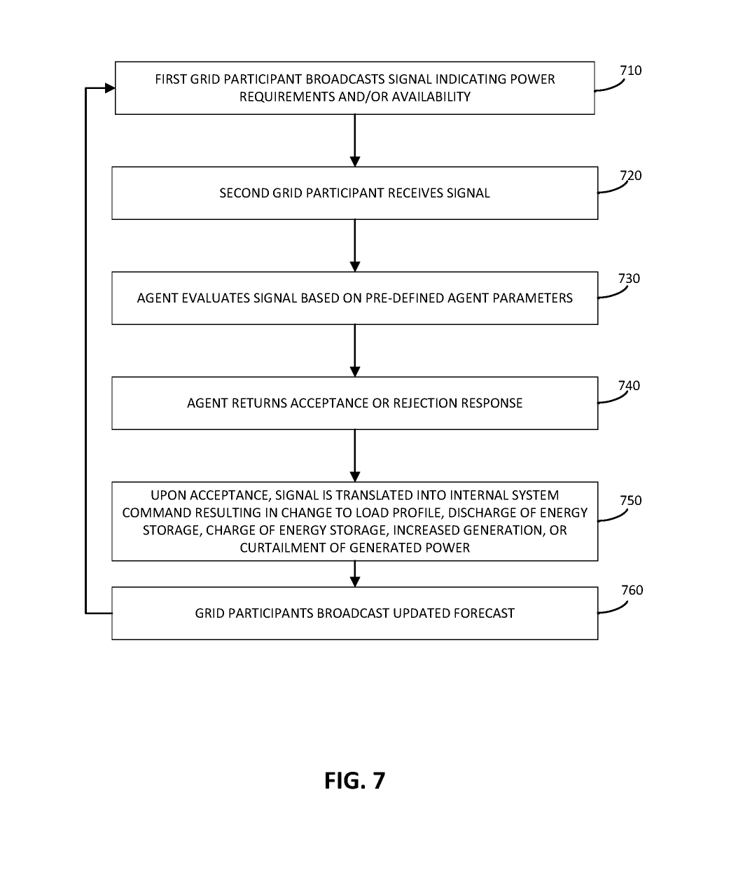

FIG. 7 depicts an example communication process between two grid participants, in accordance with various aspects of the present disclosure. The process depicted in FIG. 7 is intended provide an example of signaling and signal processing that may occur in the particular scenario shown and described. It should be appreciated that various other energy sharing scenarios (e.g., those described above) may be used in place of the particular scenario described in FIG. 7. Additionally, those components in FIG. 7 described above in reference to FIGS. 1-6 may not be described again herein for purposes of clarity and brevity.

Processing may begin at action 710, at which a first grid participant broadcasts signal indicating power requirements and/or availability. In the example, the first grid participant may be an energy consumer (e.g., a residential consumer) and the signal may request additional energy.

Processing may continue from action 710 to action 720, “Second grid participant receives signal.” At action 720, a second grid participant may receive the signal from the first grid participant. To continue the example, the second grid participant may be a microgrid comprising solar photovoltaic generation, energy storage (e.g., one or more batteries) and a series of critical (non-dispatchable) loads. In the microgrid configuration of the second grid participant, excess solar generation may be sent to the batteries for storage by default.

Processing may continue from action 720 to action 730, “Agent evaluates signal based on pre-defined parameters.” At action 730, the agent of the second grid participant may determine that there is currently more solar energy production than can be used by the local critical loads and that currently the excess energy is being sent to storage (e.g., to the one or more batteries). The agent may tentatively add the requested power from the first grid participant (e.g., the energy consumer) to the critical loads of the second grid participant and may re-forecast the energy profile for the system. The forecast generator of the agent of the second grid participant may determine that, over the course of the day, there will be more than enough excess solar generation to fill the battery beyond a threshold level even with the addition of the critical load represented by the signal sent from the first grid participant. Accordingly, at action 740, the agent returns a signal indicating an acceptance response. In another example, the forecast generator of the agent may determine that the amount of excess solar generation (e.g., the amount in excess of the battery threshold) may be less than the amount requested by the first grid participant. In such an example, the agent of the second grid participant may send a partial acceptance at action 740 indicating the amount of energy that the second grid participant is able to supply to the first grid participant. Generally, as described herein, when one grid participant agrees to supply an amount of energy to another grid participant, the “supplying” grid participant may provide the agreed upon amount of energy to a particular line accessible by the “accepting” grid participant. Similarly, the “accepting” grid participant uses the agreed upon amount of energy from the particular line. The first grid participant may thereafter update its requirements and broadcast a new signal requesting the remainder of the required energy.

In another example, if the agent forecasted that the solar generation for the day would not be enough to keep the energy storage over the threshold level with the addition of the new critical load, the agent may send a rejection signal to the first grid participant at action 740, rejecting the request for additional energy.

Processing may continue from action 740 to action 750, “Upon acceptance, signal is translated into an internal system command resulting in change to load profile, discharge of energy storage, charge of energy storage, increased generation, and/or curtailment of generated power.” For example, if the second grid participant determines, at action 730 that it can supply all of the energy requested by the first grid participant, the agent of the second grid participant may translate the signal into an internal system command effective to change the load profile of the second grid participant to incorporate the added load of the first grid participant.

Processing may continue from action 750 to action 760, “Grid participants broadcast updated forecast.” Grid participants broadcast an updated signals indicating desired power and/or power availability.

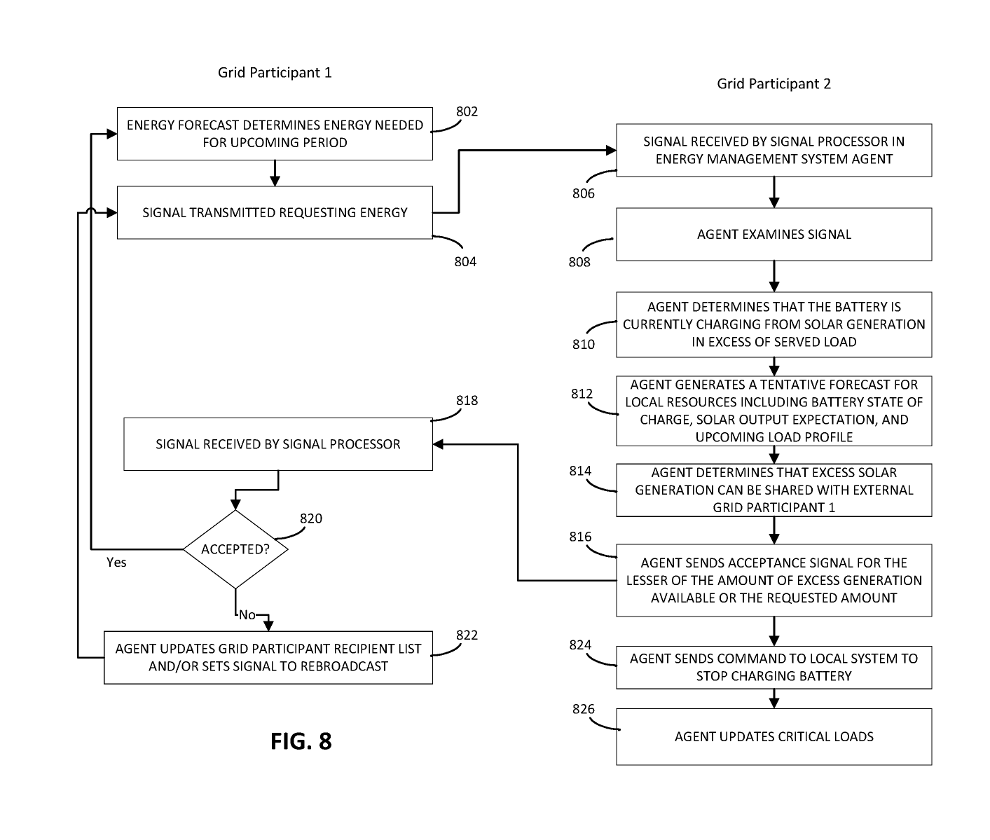

FIG. 8 depicts example communication and signal processing of two grid participants, in accordance with an embodiment of the present disclosure. The process depicted in FIG. 8 is intended provide an example of signaling and signal processing that may occur in the particular scenario shown and described. It should be appreciated that various other energy sharing scenarios (e.g., those described above) may be used in place of the particular scenario described in FIG. 8. Additionally, those components in FIG. 8 described above in reference to FIGS. 1-7 may not be described again herein for purposes of clarity and brevity.

Processing in FIG. 8 may begin at action 802, at which Grid Participant 1 may generate an energy forecast for an upcoming period. At action 802, Grid Participant 1 may determine that a particular amount of energy is required for the upcoming period. At action 804, Grid Participant 1 may broadcast a signal requesting the required amount of energy for the upcoming time period to all available energy-sharing partners. In various examples and as described in further detail below, a list of available energy-sharing partners (e.g., grid participants) may be received from a directory server.

At action 806, the agent of Grid Participant 2 may receive the signal from Grid Participant 1. At action 808, a signal processor of an agent of Grid Participant 2 may examine the signal received from Grid Participant 1. At action 810, the agent of Grid Participant 2 may determine that a battery of Grid Participant 2 is currently charging in excess of the current load of Grid Participant 2. At action 812, the agent of Grid Participant 2 generates a tentative forecast for energy requirements/production including a battery state of charge, solar output expectation and upcoming load profile. At action 814, the agent may determine that excess solar generation can be shared with Grid Participant 1 based on the forecast generated at action 812. At action 816, the agent of Grid Participant 2 may send an acceptance signal for the lesser of the amount of excess solar generation available or the amount requested by Grid Participant 1 in the signal sent at action 804.

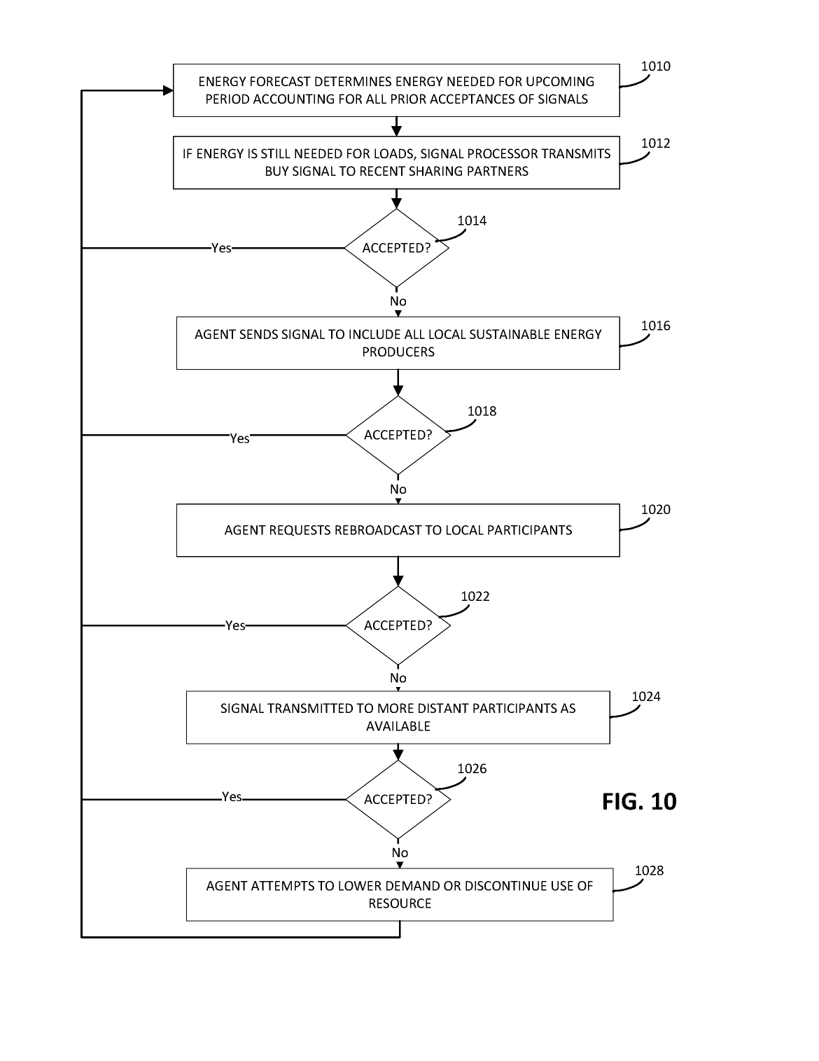

At action 818, the acceptance signal may be received by a signal processor of the agent of Grid Participant 1. If the signal indicates a full acceptance in step 820, indicating that Grid Participant 2 is able to supply all energy requested by Grid Participant 1, processing may return to action 802. If the signal is not fully accepted, the agent of Grid Participant 1 may determine the amount of energy still required and may update the grid participant list (e.g., may remove Grid Participant 2 from a list to which to send a new signal requesting the balance of the required energy) at action 822. Further, returning to action 804 the agent of Grid Participant 1 may rebroadcast the signal to all energy sharing partners apart from Grid Participant 2. As shown in FIG. 10 and described below, the agent may iteratively alter the list of grid participants to which to send the signal based on various programmable parameters.

At action 824, the agent of Grid Participant 2 may send an executable command to the local energy system to stop charging the battery. At action 826, the agent of Grid Participant 2 may update an energy forecast to account for the critical load represented by Grid Participant 1.

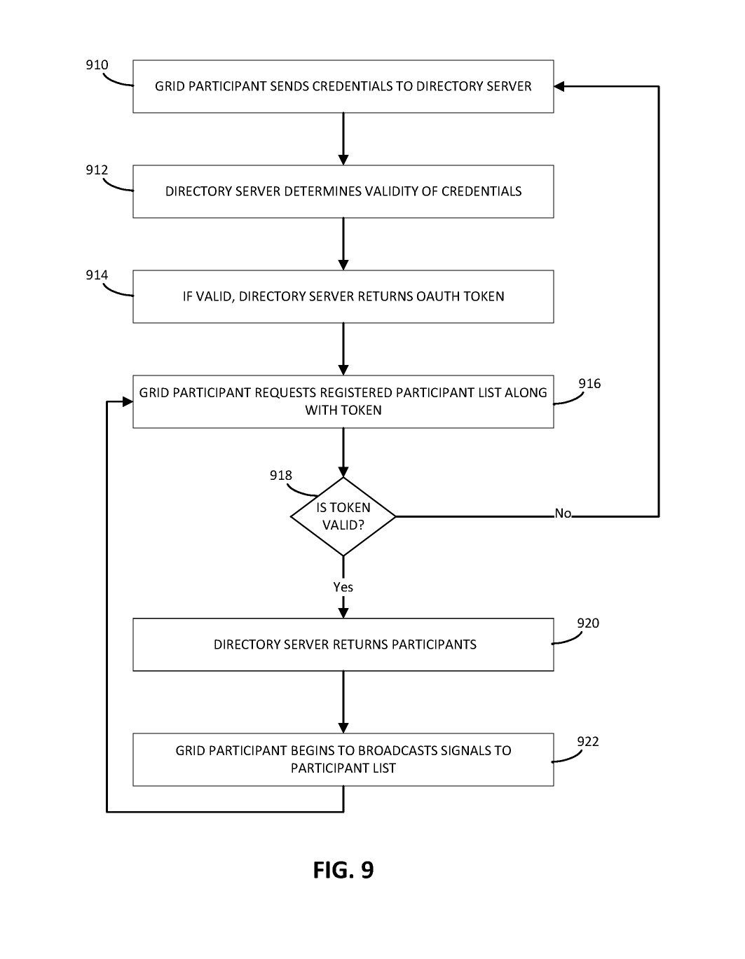

FIG. 9 depicts an example process for communicating with a directory server, in accordance with various aspects of the present disclosure. The process depicted in FIG. 9 is intended provide an example of communication with a directory server to find an authenticate grid participants. In at least some examples, the directory server described in FIG. 9 may be implemented by one or more agents configured in communication with one or more grid participants in a mesh energy sharing network. Additionally, those components in FIG. 9 described above in reference to FIGS. 1-8 may not be described again herein for purposes of clarity and brevity.

Prior to bilateral sharing of power, grid participants gather a list of energy sharing partners (e.g., other grid participants). One or more of the grid participants (and/or the agents of the grid participants) may be designated as a directory server (e.g., server 230 depicted in FIG. 2). In various other examples, an independent device or devices may serve as the director server. Each agent may be required to have authentication and authorization to a directory server through an external registration process. At action 910, the agent of a grid participant may send its credentials to the directory server. The agent may receive its credentials through a registration process with the directory server (not shown).

At action 912, the directory server may determine the validity of the credentials. At action 914, if the credentials are determined to be valid, the directory server may return an OAuth token (e.g., a validation token) to the agent of the grid participant. At action 916, the OAuth token may be used to request a participant list from the directory server. The participant list may comprise attributes that allow the agent to signal the appropriate energy sharing partners based on the message of the signal that the agent needs to send (e.g., energy request, curtailment signal, surplus energy available, etc.). Additionally, the participant list comprises attributes of the various sharing partners, such as supported protocols, supported standards, location information, signals supported, grid participant data such as a type of energy resource (e.g., renewable or non-renewable), availability of an agent to translate/rebroadcast signals, percentage uptime, ability to separate from the grid, reliability in terms of complying with forecasted energy, etc. Another example of an attribute that may be described in the participant list may be an expected response rate. In an example, an agent representing an HVAC unit may not be able to provide a fast response, while an agent representing a battery-powered grid participant may be able to response more quickly. Accordingly, the participant list may indicate an average expected response rate for each grid participant according to past performance and/or according to the type of energy resources/loads associated with the grid participants.

If the OAuth token supplied with the participant list request is determined to be valid at action 918 the directory server may return the list of participants at action 920. In at least some examples, the directory server may only return a list of participants that are located within a pre-specified distance of the requesting grid participant. In other examples, the list of participants may only include a particular type of energy resource (e.g., only renewable energy resources or only non-renewable energy resources). As described below in reference to FIG. 10, the query for lists of participants may be iteratively and programmatically expanded according to rules provided to the agent and depending on the number of available participants for each query (or lack thereof). In other examples, agents may receive a full directory of other grid participants from the directory server, but may initially send signals to only those grid participants that comply with the rules of the agent. If no grid participants are found that are able to fulfill the request from the broadcasting agent, the agent may expand the broadcast to other grid participants, according to rules of the agent. An example of an iterative broadcast by an agent is depicted in FIG. 10 and described below.

At action 922, the grid participant may broadcast signals to one or more of the grid participants on the participant list returned from the server. The broadcasting grid participant may broadcast using protocols/standards that are compliant with the grid participants on the participant list. In other examples, if one or more of the grid participants on the participant list use protocols that are not supported by the broadcasting grid participant, the broadcasting grid participant may request translation and rebroadcast from an agent offering translation/rebroadcast services.

In various examples, multiple directory servers may be present in the same power distribution circuit. For example, an energy management system for a microgrid may host a local directory service/server for connected energy assets, and may also broadcast signals to participants selected from an external directory service.

As the network of participants grows, the broadcast methodology may provide safe-guards to prevent over-communication and actions which could overwhelm both the data network and the energy grid. Although it will be left to the grid participants' agents or the hosts of the agents to defend against denial of service attacks (as with any software platform), the agent's signal processor's broadcasting methodology is a factor of the type of agent. For example, agents of passive energy consumers may have more infrequent readings from their smart meter, perhaps as infrequently as once per hour, and should therefore limit broadcasts outbound.

An agent's recipient list for each iterative broadcast may use the attributes of the grid participants to include a wider spectrum of potential energy sharing partners until a signal is accepted. Agents may prioritize recipient lists based on, for example, frequent energy sharing partners, local versus more distant grid participants, renewable versus non-renewable, and supported protocols versus rebroadcast. A sequence of broadcasting signals is illustrated in FIG. 10, with examples of methods used to determine broadcast recipients and frequency.

FIG. 10 depicts an example process for broadcasting signals to other grid participants, in accordance with various aspects of the present disclosure. Those components in FIG. 10 that have been described above in reference to FIGS. 1-9 may not be described again herein for purposes of clarity and brevity.

Processing may begin at action 1010 at which an agent may forecast energy required for an upcoming period accounting for all prior acceptances of energy sharing signals with other grid participants that may impact the upcoming period. In the example depicted in FIG. 10 a determination may be made that the grid participant requires additional energy to satisfy critical loads. As described previously in FIG. 9, the agent may acquire a list of grid participants along with attributes of these grid participants from a directory server.

Processing may continue from action 1010 to action 1012, at which a signal requesting the additional energy may be broadcast to recent sharing partners. It should be appreciated that the prioritization of grid participants to which to send the signals related to energy sharing is customizable by the particular grid participant. FIG. 10 depicts an example of a particular iterative broadcast for the agent of an exemplary grid participant. In the example depicted in FIG. 10, the particular agent has been programmed to initially broadcast to recent sharing partners.

Processing may continue from action 1012 to action 1014 at which a determination may be made whether the signal requesting energy was accepted and thus that no further signal need be sent as the energy requirements may be fulfilled. If the signal has not been accepted, processing may proceed from action 1014 to action 1016.

At action 1016, the agent may send the signal to all local (e.g. within a predefined geographic distance) sustainable energy producers. In a different example, the agent may send the signal to all local energy producers, regardless of type. As described above, the iterative process for sending signals to other grid participants may be configurable by individual agents. Processing may continue from action 1016 to action 1018 at which a determination may be made whether the signal requesting energy from local sustainable energy producers was accepted and thus that no further signal need be sent as the energy requirements may be fulfilled. If the signal has not been accepted, processing may proceed from action 1018 to action 1020 at which the agent may request rebroadcast to all local participants. In various examples, timers may be used by the agent to determine how long to wait for a response signal before proceeding to the next action (e.g., the next iteration of the search for an available grid participant).

At action 1022 a determination may be made whether the rebroadcast of the signal to all local participants was accepted and thus that no further signal need be sent as the energy requirements may be fulfilled. If the signal has not been accepted, processing may proceed from action 1022 to action 1024. At action 1024 the signal may be sent to more distant participants (e.g., the geographical range may be expanded).

At action 1026 a determination may be made whether the signal to distant participants was accepted and thus that no further signal need be sent as the energy requirements may be fulfilled. If the signal has not been accepted, processing may proceed from action 1026 to action 1028.

At action 1028, the agent may determine that no available participants are able to supply the requested energy at the current time. As such, the agent may either wait a specified amount of time before rebroadcasting or may attempt to lower energy demand or discontinue use of the resource requiring the energy. In various examples, timers may be employed to prevent grid participants from overwhelming the network with constant requests. Additionally, in some examples, grid participants that are generating too much network traffic (“noisy participants”) may be monitored, tracked, and/or reported to the directory server. The directory server and/or other systems may be effective to enforce network traffic regulations on noisy participants. For example, a noisy participant may have their authorization credentials to the directory server revoked until they are brought into compliance. Additionally, centralized messaging queues at server 230 (or another centralized computing device) may be used to curate the messages sent by noisy grid participants.

Among other potential benefits, a system in accordance with embodiments of the present disclosure allows for a decentralized mesh energy network to distribute energy to where it is needed when it is needed without requiring centralized control. Advantageously, the methodologies and systems described herein can be used with existing infrastructure and with the variety of different and incompatible communication protocols and standards already in use without requiring additional and expensive infrastructure. The methods and systems described herein provide for bilateral communication between remotely located grid participants and allow for load-balancing across a power grid, increasing the efficiency of energy production and energy sharing.

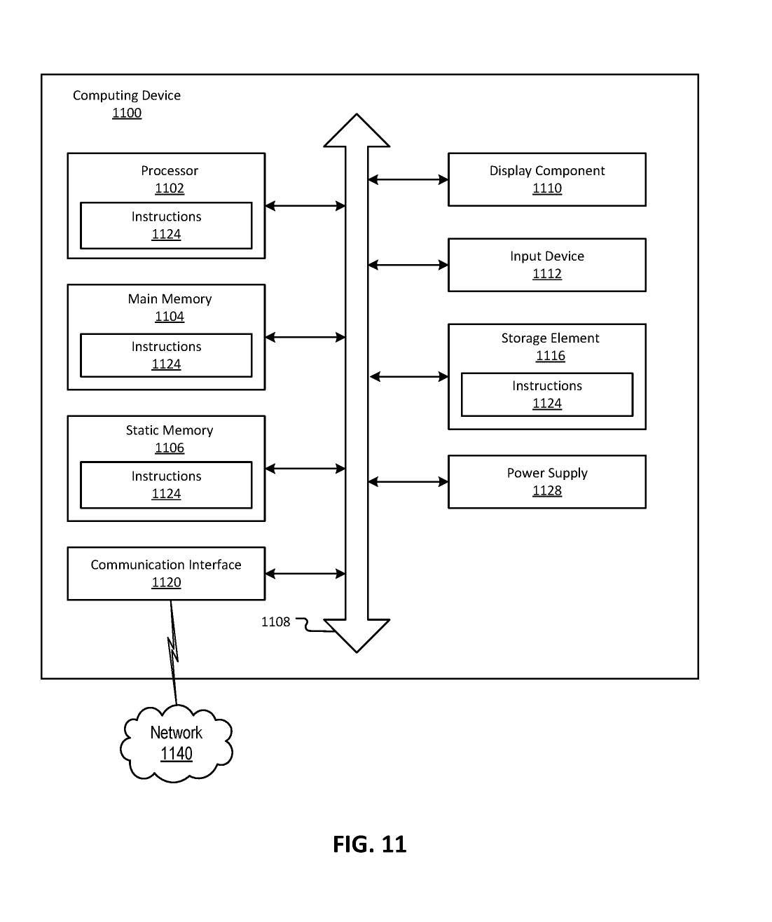

Referring to FIG. 11, the block diagram illustrates components of a computing device 1100, according to some example embodiments, able to read instructions 1124 from a non-transitory machine-readable storage medium (e.g., a hard drive storage system) and perform any one or more of the methodologies discussed herein, in whole or in part. Specifically, FIG. 11 shows the computing device 1100 in the example form of a computer system within which the instructions 1124 (e.g., software, a program, an application, an applet, an app, or other executable code) for causing the computing device 1100 to perform any one or more of the methodologies discussed herein may be executed, in whole or in part. Computing device 1100 may represent the general architecture of an agent, as described herein. Additionally, in at least some examples, an agent may comprise a combination of specialized hardware for monitoring and/or forecasting energy profiles of grid participants and software executing on computing device 1100.

In alternative embodiments, the computing device 1100 operates as a standalone device or may be connected (e.g., networked) to other computing devices (such as server 230 depicted in FIG. 2). In a networked deployment, the computing device 1100 may operate in the capacity of a server computing device or a client computing device in a server-client network environment, or as a peer computing device in a distributed (e.g., peer-to-peer) network environment. The computing device 1100 may include hardware, software, or combinations thereof, and may, as example, be a server computer, a client computer, a personal computer (PC), a tablet computer, a laptop computer, a netbook, a cellular telephone, a smartphone, a smart meter, a set-top box (STB), a personal digital assistant (PDA), a web appliance, a network router, a network switch, a network bridge, or any computing device capable of executing the instructions 1124, sequentially or otherwise, that specify actions to be taken by that computing device. Further, while only a single computing device 1100 is illustrated, the term “computing device” shall also be taken to include any collection of computing devices that individually or jointly execute the instructions 1124 to perform all or part of any one or more of the methodologies discussed herein.

The computing device 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus or other communication interface 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The computing device 1100 may further include a display component 1110. The display component 1110 may comprise, for example, one or more devices such as cathode ray tubes (CRTs), liquid crystal display (LCD) screens, gas plasma-based flat panel displays, LCD projectors, or other types of display devices.

The computing device 1100 may include one or more input devices 1112 operable to receive inputs from a user. The input devices 1112 can include, for example, a push button, touch pad, touch screen, wheel, joystick, keyboard, mouse, trackball, keypad, accelerometer, light gun, game controller, or any other such device or element whereby a user can provide inputs to the computing device 1100. These input devices 1112 may be physically incorporated into the computing device 1100 or operably coupled to the computing device 1100 via wired or wireless interface. For computing devices with touchscreen displays, the input devices 1112 can include a touch sensor that operates in conjunction with the display component 1110 to permit users to interact with the image displayed by the display component 1110 using touch inputs (e.g., with a finger or stylus).

The computing device 1100 may also include at least one communication interface 1120, comprising one or more wireless components operable to communicate with one or more separate devices within a communication range of the particular wireless protocol. The wireless protocol can be any appropriate protocol used to enable devices to communicate wirelessly, such as Bluetooth, cellular, IEEE 802.11, or infrared communications protocols, such as an IrDA-compliant protocol. It should be understood that the communication interface 1120 may also or alternatively comprise one or more wired communications interfaces for coupling and communicating with other devices.

The computing device 1100 may also include a power supply 1128, such as, for example, a rechargeable battery operable to be recharged through conventional plug-in approaches or through other approaches, such as capacitive charging. Alternatively, the power supply 1128 may comprise a power supply unit which converts AC power from the power grid to regulated DC power for the internal components of the device 1100.

The computing device 1100 may also include a storage element 1116. The storage element 1116 includes the machine-readable medium on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the computing device 1100. The instructions 1124 may also reside in the static memory 1106.

Accordingly, the main memory 1104 and the processor 1102 may also be considered machine-readable media (e.g., tangible and non-transitory machine-readable media). The instructions 1124 may be transmitted or received over a network 1140 via the communication interface 1120. For example, the communication interface 1120 may communicate the instructions 1124 using any one or more transfer protocols (e.g., HTTP and/or the other protocols described herein).

The computing device 1100 may be implemented as any of a number of electronic devices, such as a tablet computing device, a smartphone, a media player, a portable gaming device, a portable digital assistant, a laptop computer, or a desktop computer. In some example embodiments, the computing device 1100 may have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a non-transitory machine-readable medium capable of storing data temporarily or permanently and may be taken to include, but not be limited to, random-access memory (RAM), read-only memory (ROM), buffer memory, flash memory, and cache memory. The machine-readable medium is non-transitory in that it does not embody a propagating signal. While the machine-readable medium is described in example embodiments as a single medium, the term “machine-readable medium” should be taken to include a single medium or multiple media (e.g., a centralized or distributed database, or associated caches and servers) able to store instructions 1124. The term “machine-readable medium” shall also be taken to include any medium, or combination of multiple media, that is capable of storing the instructions 1124 for execution by the computing device 1100, such that the instructions 1124, when executed by one or more processors of the computing device 1100 (e.g., processor 1102), cause the computing device 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

Specific elements of any embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of energy sharing, the method comprising:
sending, by a first computing device associated with a first grid participant, a request for a list of grid participants to a directory server;
receiving, by the first computing device, the list of grid participants from the directory server;
determining, by the first computing device, an energy profile of the first grid participant;
sending, by the first computing device, a first signal to a second grid participant of the list of grid participants, wherein the first signal comprises a first indication of the energy profile of the first grid participant;
receiving, by the first computing device from a second computing device associated with the second grid participant, a second signal in response to the first signal, wherein the second signal indicates an availability of the second grid participant to participate in energy sharing with the first grid participant; and
providing energy to a line accessible by the first grid participant and the second grid participant according to the energy profile of the first grid participant.

2. The method of claim 1, wherein:
the energy profile indicates a first amount of energy desired by the first grid participant;
the first signal indicates the first amount of energy;
the second signal further comprises a second indication of a second amount of energy that the second grid participant can provide to the line; and
the providing energy to the line comprises:
sending the second amount of energy from the second grid participant to the line.

3. The method of claim 2, wherein the second amount of energy is less than the first amount of energy, the method further comprising:
sending, by the first computing device, a third signal to at least one other gird participant of the list of grid participants different than the second grid participant, wherein the third signal indicates a third amount of energy, wherein the third amount of energy is a difference between the first amount of energy and the second amount of energy;
receiving, by the first computing device from a third computing device associated with a third grid participant, a fourth signal in response to the third signal, wherein the fourth signal comprises a third indication that the third grid participant can supply the third amount of energy to the line; and
receiving, by the first grid participant, the third amount of energy from the line.

4. The method of claim 1, wherein:
the energy profile indicates a first amount of energy available for sharing by the first grid participant;
the first signal indicates the first amount of energy;
the second signal further comprises a request for at least a portion of the first amount of energy from the first grid participant; and
the providing energy to the line comprises:
sending the first amount of energy from the first grid participant to the line.

5. The method of claim 1, further comprising sending the first signal to a third computing device effective to translate the first signal from a first protocol to a second protocol.

6. The method of claim 1, further comprising:
determining a subset of grid participants from the list of grid participants based on each grid participant of the subset of grid participants having a first attribute;
prior to sending the first signal to the second grid participant, sending the first signal to the subset of grid participants; and
determining that grid participants of the subset of grid participants are currently unavailable to respond to the first signal.

7. The method of claim 1, wherein determining, by the first computing device, the energy profile of the first grid participant comprises communicating by the first computing device with an energy resource of the first grid participant via a first communication protocol, the method further comprising:
determining, by the first computing device, a second communication protocol of the second computing device based on attributes of the second grid participant received from the directory server, wherein the first signal is sent using the second communication protocol.

8. The method of claim 1, wherein:
the energy profile indicates a first amount of energy desired by the first grid participant;
the first signal indicates the first amount of energy;
the second signal further comprises a second indication of a second amount of energy by which the second grid participant can reduce a load; and
the providing energy to the line comprises:
reducing energy provided to the line by the first grid participant by the second amount of energy.

9. The method of claim 1, further comprising:
sending, by the first computing device, credentials to the directory server;
receiving, by the first computing device, a validation token from the directory server based on a first determination by the directory server that the credentials correspond to the first computing device;
sending, by the first computing device, the validation token with the request for the list of grid participants; and
receiving, by the first computing device, the list of grid participants based on a second determination by the directory server that the validation token is valid, wherein the list of grid participants comprises attributes of each grid participant in the list of grid participants.

10. A method of energy sharing, the method comprising:
sending, by a first computing device associated with a first grid participant, a request for a list of grid participants to a directory server;
receiving, by the first computing device, the list of grid participants from the directory server, wherein the list of grid participants associates each grid participant of the list of grid participants with at least one attribute, wherein the at least one attribute comprises at least one of: first data indicating supported protocols, second data comprising location information, and third data indicating an energy resource type;
determining, by the first computing device, an energy profile of the first grid participant, wherein the energy profile indicates a first amount of energy desired by the first grid participant, wherein the first amount of energy is determined based on a first forecast of current and forecasted energy demands of the first grid participant;
sending, by the first computing device, a first signal to at least one grid participant of the list of grid participants, wherein the first signal comprises a first indication of the first amount of energy;
receiving, by the first computing device from a second computing device associated with a second grid participant of the list of grid participants, a response signal in response to the first signal, wherein the response signal indicates an availability of the second grid participant to provide a portion of the first amount of energy;
receiving, by the first grid participant, the portion of the first amount of energy from a line accessible by the first grid participant and the second grid participant;
determining, by the first computing device, an updated energy profile of the first grid participant, wherein the energy profile indicates a second amount of energy desired by the first grid participant, wherein the second amount of energy is determined based on a second forecast of current and forecasted energy demands of the first grid participant and based on a capability of the second grid participant to provide the first amount of energy; and
sending, by the first computing device, a second signal to at least one grid participant of the list of grid participants different than the second grid participant, wherein the second signal comprises a second indication of the second amount of energy.

11. A computing device associated with a first grid participant, the computing device comprising:
at least one processor; and
a memory configured in communication with the at least one processor, the memory storing instructions that when executed by the at least one processor cause the computing device to perform a method comprising:
sending a request for a list of grid participants to a directory server;
receiving the list of grid participants from the directory server;
determining an energy profile of the first grid participant via communication with a smart meter of the first grid participant, wherein the communication is in a first communication protocol;
sending a first signal in a second communication protocol to a second grid participant of the list of grid participants, wherein the first signal comprises a first indication of the energy profile of the first grid participant;
receiving, from a second computing device associated with the second grid participant, a second signal in response to the first signal, wherein the second signal indicates an availability of the second grid participant to participate in energy sharing with the first grid participant; and
providing energy to a line accessible by the first grid participant and the second grid participant according to the energy profile of the first grid participant.

12. The computing device of claim 11, wherein:
the energy profile indicates a first amount of energy desired by the first grid participant;
the first signal indicates the first amount of energy;
the second signal further comprises a second indication of a second amount of energy that the second grid participant can provide to the line; and
the providing energy to the line comprises:
sending the second amount of energy from the second grid participant to the line.

13. The computing device of claim 12, wherein the second amount of energy is less than the first amount of energy, and wherein the instructions, when executed by the at least one processor are effective to perform the method further comprising:
sending, by the computing device, a third signal to at least one other gird participant of the list of grid participants different than the second grid participant, wherein the third signal indicates a third amount of energy, wherein the third amount of energy is a difference between the first amount of energy and the second amount of energy;
receiving, from a third computing device associated with a third grid participant, a fourth signal in response to the third signal, wherein the fourth signal comprises a third indication that the third grid participant can supply the third amount of energy to the line; and
receiving, by the first grid participant, the third amount of energy from the line.

14. The computing device of claim 11, wherein:
the energy profile indicates a first amount of energy available for sharing by the first grid participant;
the first signal indicates the first amount of energy;
the second signal further comprises a request for at least a portion of the first amount of energy from the first grid participant; and
the providing energy to the line comprises:
sending the first amount of energy from the first grid participant to the line.

15. The computing device of claim 11, wherein the instructions when executed by the at least one processor are effective to perform the method further comprising sending the first signal to a third computing device effective to translate the first signal from the second communication protocol to a third communication protocol.

16. The computing device of claim 11, wherein the instructions when executed by the at least one processor are effective to perform the method further comprising:
determining a subset of grid participants from the list of grid participants based on each grid participant of the subset of grid participants having a first attribute;
prior to sending the first signal to the second grid participant, sending the first signal to the subset of grid participants; and
determining that grid participants of the subset of grid participants are unavailable to respond to the first signal.

17. The computing device of claim 16, wherein the first attribute comprises at least one of a proximity of a particular grid participant to the first grid participant and a type of energy resource of the particular grid participant.

18. The computing device of claim 11, wherein the instructions when executed by the at least one processor are effective to perform the method further comprising:
determining the second communication protocol of the second computing device based on attributes of the second grid participant received from the directory server.

19. The computing device of claim 11, wherein:
the energy profile indicates a first amount of energy desired by the first grid participant;
the first signal indicates the first amount of energy;
the second signal further comprises a second indication of a second amount of energy by which the second grid participant can reduce a load; and
the providing energy to the line comprises:
reducing energy provided to the line by the first grid participant by the second amount of energy.

20. The computing device of claim 11, wherein the instructions when executed by the at least one processor are effective to cause the computing device to perform the method further comprising:
sending credentials to the directory server;
receiving a validation token from the directory server based on a first determination by the directory server that the credentials correspond to the computing device;
sending the validation token with the request for the list of grid participants; and
receiving the list of grid participants based on a second determination by the directory server that the validation token is valid, wherein the list of grid participants comprises attributes of each grid participant in the list of grid participants.
